(19) United States
(12) Patent Application Publication
(10) Pub. No.: US 2014/0263535 A1
(43) Pub. Date: Sep. 18, 2014

(54) DIRECT CURRENT FASTENING DEVICE AND RELATED CONTROL METHODS

(71) Applicant: TECHTRONIC POWER TOOLS TECHNOLOGY LIMITED, Tortola (VG)

(72) Inventors: Umesh Rajani, Anderson, SC (US); G. Michael Hornick, Anderson, SC (US); James A. Patton, Anderson, SC (US); Michael Buckner, Central, SC (US); John Schnell, Anderson, SC (US); Edward A. Pomeroy, Piedmont, SC (US)

(73) Assignee: TECHTRONIC POWER TOOLS TECHNOLOGY LIMITED, Tortola (VG)

(21) Appl. No.: 13/796,980

(22) Filed: Mar. 12, 2013

(51) Int. Cl. B25C 1/00; B25C 1/06

(52) U.S. Cl. CPC B25C 1/008; B25C 1/06
USPC 227/2; 173/1

(57) ABSTRACT

A direct current fastening device and related control methods. The fastening device is powered by a direct current power source and includes a variety of safety and control features that allow the fastening device to be safety operated without, for example, a mechanical safety linkage or assembly between a trigger and a fastener firing portion (e.g., a nose switch) that prohibits the operation of the fastening device. Rather, the fastening device described herein employs a controller, a variety of switches, and monitoring techniques to ensure the safe and reliable operation of the fastening device. The configuration of the controller, for example, replaces the mechanical linkages and assemblies between the trigger and the fastener firing portion (e.g., a nose switch) that are ubiquitous safety features for such fastening devices.

### BACKGROUND

This invention relates to an electric fastening device.

### SUMMARY

The invention provides a fastening device that includes a variety of safety and control features that are used to control the device without the use of, for example, a mechanical linkage or mechanical safety assembly connected between a trigger of the device and a firing portion (e.g., a nose switch) of the device.

Conventional electric fastening devices include a variety of safety mechanisms that are implemented to prevent the devices from firing a fastener when the device is in a non-use position (e.g., not pressed against a surface) or prevent the trigger from being pulled altogether. Although such safety mechanisms or assemblies are ubiquitous in the field of electric fastening devices, such safety mechanisms and assemblies are prone to failure, involve complicated mechanical designs, and require complex mechanical assembly. Nevertheless, such safety mechanisms and assemblies are still used due to potential safety concerns related to electronic control of electric fastening devices, such as the fastening device being able to fire a fastener when the device is in a non-use position.

In one embodiment, the invention provides an electric fastening device that includes a controller that receives a signal associated with a trigger switch and a signal associated with a nose switch. Based on the signal from the trigger switch and the signal from the nose switch, the controller controls the energization of a controller or control board (e.g., a printed circuit board), the activation of a worklight, and the firing of a fastener. The fastening device is also configured to monitor the status and health of at least one drive switch and at least one brake switch to determine whether the switches are functioning properly, and whether the fastening device can be safely operated.

In another embodiment, the invention provides a fastening device that includes a trigger portion, a nose portion, a fastener magazine configured to receive a fastener, a first switch, a second switch, and a controller. The first switch has an operational state, and the operational state of the first switch is one of an open state and a closed state. The second switch has an operational state, and the operational state of the second switch is one of an open state and a closed state. The controller is configured to receive a first signal associated with the operational state of the first switch, receive a second signal associated with the operational state of the second switch, and initiate a firing operation for the fastener when the first signal associated with the operational state of the first switch is indicative of the first switch being in the closed state and when the second signal associated with the operational state of the second switch is indicative of the second switch being in the closed state.

In another embodiment, the invention provides a method of operating a fastening device that includes a controller. The method includes receiving, at the controller, a first signal associated with an operational state of a first switch, receiving, at the controller, a second signal associated with an operational state of a second switch, and initiating a firing operation for a fastener. The operational state of the first switch is one of an open state and a closed state, and the operational state of the second switch is one of an open state and a closed state. The firing operation is initiated when the first signal associated with the operational state of the first switch is indicative of the first switch being in the closed state and when the second signal associated with the operational state of the second switch is indicative of the second switch being in the closed state. The fastener is fired following the initiation of the firing operation.

In another embodiment, the invention provides a fastening device that includes a trigger portion, a nose portion, and a fastener magazine configured to receive a fastener. The fastening device also includes a first switch, a second switch, and a controller. The first switch has an operational state, and the operational state of the first switch is one of an open state and a closed state. The second switch has an operational state, and the operational state of the second switch is one of an open state and a closed state. The controller is configured to receive a first signal associated with the operational state of the first switch, receive a second signal associated with the operational state of the second switch, and initiate a fastener firing operation when the first signal associated with the operational state of the first switch is indicative of the first switch being in the closed state and when the second signal associated with the operational state of the second switch is indicative of the second switch being in the closed state.

Other aspects of the invention will become apparent by consideration of the detailed description and accompanying drawings.

### BRIEF DESCRIPTION OF THE DRAWINGS

FIG. 1 illustrates a direct current fastening device.

FIG. 2 illustrates a direct current fastening device and a battery pack for powering the fastening device.

FIG. 3A is an electrical schematic diagram of a fastening device according to an embodiment of the invention.

FIG. 3B is an electrical schematic diagram of a fastening device according to an embodiment of the invention.

FIG. 4 illustrates a controller for a fastening device according to an embodiment of the invention.

FIG. 5 illustrates a process for energizing a circuit board according to an embodiment of the invention.

FIG. 6 illustrates a process for activating a worklight of a fastening device according to an embodiment of the invention.

FIGS. 7-8 illustrate a process for operating a fastening device according to an embodiment of the invention.

FIG. 9 illustrates a fastener firing process according to an embodiment of the invention.

FIG. 10 illustrates a device disabling sequence according to an embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Embodiments of the invention described herein relate to an electric fastening device powered by a direct current (“DC”) power source, such as a battery pack. The fastening device includes a variety of safety and control features that allow the fastening device to be safety operated without, for example, a mechanical safety linkage or assembly between a trigger and a firing portion that mechanically prohibits the operation of the fastening device. Rather, the fastening device described herein employs a controller, a variety of switches, and monitoring techniques to ensure the safe and reliable operation of the fastening device. The configuration of the controller, for example, replaces the mechanical linkages and assemblies that are ubiquitous safety features for such fastening devices. The switches include a nose switch, a trigger switch, a sharkfin switch, a drive switch, and a brake switch. The fastening device is also operable to monitor the health of various switches within the fastening device to ensure their proper operation, and to ensure that none of the switches have failed.

FIG. 1 illustrates an electric fastening device 100. The fastening device 100 includes, among other things, a handle 105, a battery pack interface portion 110, a fastener magazine 115, a depth selection input 120, a nose or fastener firing portion 125, and a trigger or trigger portion 130. A battery pack 135 is interfaced with (e.g., removably securable to) the device 100 as illustrated in FIG. 2. In some embodiments, the device 100 does not include a mechanical safety linkage or assembly between the trigger 130 of the device 100 and the firing portion 125 (e.g., a nose switch) of the device 100. The magazine 115 is configured to receive a plurality of fastening devices (e.g., nails, staples, brads, etc.). In some embodiments, the magazine 115 includes, for example, a dry-fire lockout mechanism that inhibits the device 100 from firing a fastener when all of the fasteners have been emptied from the magazine 115. The dry-fire lockout mechanism may be mechanical in nature but is separate from the mechanical linkage or assembly between the trigger and firing portion found in conventional fastening devices.

The battery pack 135 includes a plurality of battery cells. The battery cells can be arranged in series, parallel, or a series-parallel combination. For example, the battery pack 135 can include five series-connected battery cells. In other embodiments, the battery pack 135 includes a different number of battery cells (e.g., between 3 and 12 battery cells) connected in series, parallel, or a series-parallel combination in order to produce a battery pack having a desired combination of nominal battery pack voltage and capacity.

The battery cells are lithium-based battery cells having a chemistry of, for example, lithium-cobalt (“Li—Co”), lithium-manganese (“Li—Mn”), or Li—Mn spinel. In some embodiments, the battery cells have other suitable lithium or lithium-based chemistries, such as a lithium-based chemistry that includes manganese, etc. The battery cells within the battery pack provide operational power (e.g., voltage and current) to the device 100. In one embodiment, each battery cell has a nominal voltage of approximately 3.6V, such that the battery pack has a nominal voltage of approximately 18V. In other embodiments, the battery cells have nominal voltages, such as, for example, between 3.6V and 4.2V, and the battery pack has a different nominal voltage, such as, for example, 10.8V, 12V, 14.4V, 24V, 28V, 36V, between 10.8V and 36V, etc. The battery cells also have a capacity of, for example, approximately between 1.0 ampere-hours (“Ah”) and 5.0 Ah. In exemplary embodiments, the battery cells have capacities of approximately, 1.5 Ah, 2.4 Ah, 3.0 Ah, 4.0 Ah, between 1.5 Ah and 5.0 Ah, etc. The battery cells are, for example, cylindrical 18650 battery cells (18 mm diameter and 65 mm length), such as the INR18650-15M lithium-ion rechargeable battery cell manufactured and sold by Samsung SDI Co., Ltd. of South Korea.

The device 100 includes a controller 200 electrically and/or communicatively connected to a variety of modules or components of the device 100, as shown in FIGS. 3A and 3B. For example, the illustrated controller 200 is connected to a first Hall Effect sensor module 205, a second Hall Effect sensor module 210, a circuit board or PCB energize module 215, a worklight 220, a battery voltage sense module 225, a switch status module 230, a thermal fuse 235, a trigger switch 240, a nose switch 245, a mode select switch 250, a sharkfin switch 255, a brake module 260, a drive module 265, and a motor 270. The controller 200 is also connected to other components of the device 100 (e.g., the depth selection input 120). In some embodiments, the motor 270 is a brushless DC motor (“BLDC”). In other embodiments, different types of DC motors are used, such as a brushed DC motor, a stepper motor, a synchronous motor, or motors which utilize permanent magnets.

The first Hall Effect sensor module 205 and the second Hall Effect sensor module 210 include or are connected to respective first and second Hall Effect sensors. The first Hall Effect sensor module 205 and the second Hall Effect sensor module 210 are configured to detect the position of a piston coupled to the motor 270. When firing a fastener, the motor 270 applies a force to the piston. Through a compression and vacuum cycle, the device 100 is operable to fire a fastener and return (via the vacuum) to a neutral firing position. The first Hall Effect sensor module 205 and the second Hall Effect sensor module 210, and associated Hall Effect sensors, detect the position of the piston to determine whether a firing operation has been completed. For example, the controller 200 receives a first signal from the first Hall Effect sensor module 205 indicative of piston compression during a fastener firing sequence. The controller 200 then receives a second signal from the second Hall Effect sensor module 210 indicative of the piston being refracted by the vacuum. If the controller 200 does not receive both the first signal and the second signal, or the signals are not received in an expected order (e.g., the first signal preceding the second signal), the controller 200 determines that the compression and vacuum cycle has stalled (e.g., the device 100 may not be able to fire another fastener until the cycle or the device is reset). In some embodiments, the first and second Hall Effect sensor modules 205 and 210 detect the position of the piston several times during a firing sequence. For example, the sensor modules 205 and 210 detect the initial position of the piston, the extended position (compression), and the retracted position (vacuum). If all three signals are not received in time or are not received in the correct order, the controller 200 is able to identify a fault condition.

The circuit board or PCB energize module 215 is electrically connected between both the trigger switch 240 and the sharkfin switch 255, and the controller 200. The circuit board energize module 215 receives a signal associated with the activation of the sharkfin switch 255 and/or the trigger switch 240 and, based on those signals, selectively energizes the circuits within the device 100. In some embodiments, in the absence of a signal from the sharkfin switch 255 or the trigger switch 240, the circuits within the device 100 remain de-energized, as described below. A PCB for the device 100 is general illustrated at 295.

The worklight 220 is, for example, a light-emitting diode (“LED”) worklight and includes one or more LEDs. The worklight 220 is selectively activated by the controller 200 based on signals resulting from the activation and/or deactivation of various switches within the device 100, as described below.

The battery voltage sense module 225 is configured to monitor the voltage of the battery pack 135. In some embodiments, the battery voltage sense module 225 monitors an overall battery pack stack voltage of the battery pack 135. In other embodiments, the battery voltage sense module 225 monitors individual battery cell voltages of the battery cells within the battery pack 135. For example, the battery pack 135 and the battery pack interface portion 110 can include a plurality of terminals that allow the battery voltage sense module to directly measure (or calculate from direct measurements) individual battery cell voltages. Additionally or alternatively, the battery pack 135 can provide the device 100 with information related to each individual battery cell voltage or the overall battery pack stack voltage (e.g., the battery pack 135 includes internal voltage monitoring circuitry as is known in the art). The sensed battery pack voltage or voltages are then provided to the controller 200 and used to determine, for example, if the battery pack 135 has a sufficient charge for the device 100 to complete a fastener firing operation. If the battery pack 135 has sufficient charge to complete a fastener firing operation, the controller 200 allows the device to complete the fastener firing operation. If the battery pack 135 does not have a sufficient charge to complete the fastener firing operation, the controller 200 prevents the device 100 from beginning or performing a fastener firing operation until the battery pack voltage has increased to a sufficient level (e.g., greater than 12V, greater than 14V, greater than 16V, greater than 18V, etc.).

The trigger switch 240 is included in the trigger 130 or is associated with (e.g., connected to) the trigger 130 such that the activation of the trigger 130 results in an electrical signal being provided to the controller 200 that is associated with the operational state of the trigger switch 240. As illustrated in FIGS. 3A and 3B, the trigger switch 240 is connected between a positive battery voltage, V_{BAT}, and the positive side of the motor 270. Closing the trigger switch 240 does not, however, necessarily result in the motor being energized, as described below.

The nose switch 245 is associated with (e.g., connected to) the fastener firing portion 125 of the device 100. The nose switch 245 is activated when, for example, the nose of the fastening device 100 is pressed against a surface (e.g., the surface to which a fastener is to be applied). The activation of the nose switch 245 results in an electrical signal being provided to the controller 200 that is associated with the operational state of the nose switch 245. The nose switch 245 is provided to, for example, assist in preventing a fastener from being fired when the device 100 is in a non-use position (e.g., not pressed against a surface).

The mode select switch 250 is configured to allow a user to select from a variety of modes of operation for the device 100. In the illustrated embodiment, the mode select switch 250 is illustrated as having two states. In other embodiments, the mode select switch 250 includes additional states to accommodate additional modes of operation. In some embodiments, the two states of the mode select switch 250 correspond to a single fire mode and a bump fire mode, which dictate the circumstances necessary for the device 100 to fire a fastener. For example, in the single fire mode, both the sequence of switch activations and the time frame within which the switches are activated are used to determine whether a fastener should be fired. In the bump fire mode, the sequence of switch activations is not critical, but the switches must be activated within a determined time limit. In some embodiments, the mode select switch 250 is positioned below the trigger 130 on the handle 105 of the device 100. In other embodiments, the mode select switch 250 is positioned at a different location on the device 100.

The sharkfin switch 255 is configured to control the activation of the worklight 220. For example, the worklight 220 can be activated in a variety of ways (e.g., when firing a fastener). If a user desired to activate the worklight 220 without firing a fastener, the sharkfin switch 255 can be activated. The activation of the sharkfin switch 255 results in an electrical signal being provided to the controller 200 for activating the worklight 220. The sharkfin switch 255 does not control the firing of a fastener.

The brake module 260, the drive module 265, the switch status module 230, and the thermal fuse 235 collectively form a verification and control system that ensures the device 100 is working properly and safely. For example, the brake module 260 includes a first brake switch 275 and a second brake switch 280. The drive module 265 includes a first drive switch 285 and a second drive switch 290. If the first drive switch 285 and the second drive switch 290 were to fail (e.g., be shorted or remain closed), the motor 270 would be allowed, by activating the trigger switch 240, to shoot fasteners continuously. Such an occurrence represents an unsafe condition for both the user and anyone else in the vicinity of the user. Similarly, if the first brake switch 175 and the second brake switch 280 were to fail, the motor 270 may be unable to stop in sufficient time to prevent an unintended fastener firing. The switches 275, 280, 285, and 290 are, for example, field-effect transistors (“FETs”) or another suitable type of selectively controllable semiconductor switch.

In order to prevent the failure of these switches, the switch status module 230 is provided to determine whether any of the first brake switch 275, second brake switch 280, first drive switch 285, or second drive switch 290, have failed or are otherwise not operating correctly (i.e., determine the health of the switches). The health of the drive switches 285 and 290 or the brake switches 175 and 280, can be determined using a variety of techniques. As an illustrative example, and with reference to FIG. 3A, the health of the drive and brake switches is determined by the switch status module 230 by measuring various node voltages associated with the switches.

Specifically, the switch status module is connected to the brake module 260 and the drive module 265 such that it is configured to measure a voltage between the first brake switch 275 and the second brake switch 280, as well as a voltage between the first drive switch 285 and the second drive switch 290. In some embodiments, a control or test voltage (e.g., 5V) is applied to the junction between the nodes by the controller 200 or the switch status module 230. Depending upon the status of the switches 275, 280, 285, and 290, the voltages measured by the switch status module are used to determine which, if any, of the switches have failed.

The negative end of the switch 290 is connected to the ground reference of the device 100. The positive end of the switch 290 is connected to the junction, J2. The negative end of the switch 285 is connected to the junction, J2, and the positive and of the switch 285 is connected to the negative terminal of the motor 270 and the negative end of the switch 280. The positive end of the switch 280 is connected to the junction, J1, between the switch 280 and the switch 275, and the positive end of the switch 275 is connected, through the fuse 235 and the trigger switch 240, to the battery positive voltage, V_{BAT} (e.g., 12V, 18V, etc.).

The status of the switches 275, 280, 285, and 290 can be determined at various times throughout the operation of the device 100, such as, for example, when the PCB is energized, during, after, or before a fastener firing sequence, when energizing the PCB, etc. In some instances, because of the connection of the brake module 260 and the drive module 265, one or more of the switches 275, 280, 285, 290 are selectively opened or closed in order for the controller 200 and/or the switch status module 230 to be able to properly determine the status of the switches (e.g., the health of the switches). In some embodiments, the health of the brake switches 275 and 280 is determined during a fastener firing sequence when the switches 285 and 290 are closed. Additionally, in some embodiments, the health of the drive switches 285 and 290 is determined during a braking operation when the switches 275 and 280 are closed.

As an illustrative example, and with respect to the drive module 265, a control voltage of 5V is applied by the controller 200 to the junction, J2, between the first drive switch 285 and the second drive switch 290. The switch status module 230 measures the voltage at the junction, J2. For the purposes of this example, assume that the positive end of the switch 285 is at the voltage as the battery positive voltage, V_{BAT}, because the switches 285 and 290 are open or because the brake switches 275 and 280 are both closed. If both of switches 285 and 290 are functioning properly (e.g., are not short circuited), the switch status module 230 measures the voltage at the junction, J2, to be the control voltage of 5V. If the switch 285 has failed (e.g., is short circuited), the switch status module 230 measures a voltage equal to V_{BAT} (e.g., 12V, 18V, etc.). If the switch 290 has failed (e.g., is short circuited), the switch status module 230 measures a voltage of 0V (i.e., ground potential). In either instance, or when both occur, the switch status module 230 and/or the controller 200 determine that a drive switch has failed (i.e., enters a fault condition) or is unhealthy and that the device 100 should be prevented from operating. A similar process is performed for testing the brake switches 275 and 280 by measuring the voltage at the junction, J1 and determining whether one or more of the brake switches 275 and 280 has failed (e.g., is short circuited) and is indicative of a fault condition. In some embodiments, the switch status module 230 is included in the controller 200 and is not separated from and connected to the controller 200.

FIG. 3B illustrates another embodiment of the device 100. However, in FIG. 3B, the brake module 260 includes one switch, switch 275, and the drive module 265 includes one switch, switch 285. Although both the brake module 260 and the drive module 265 include one switch as opposed to two switches, a similar procedure to that described above with respect to FIG. 3A can be performed by the controller 200 and/or switch status module 230 to determine the health of the switches 275 and 285. For example, if the switch status module measures a voltage of junction, J2, that is approximately equal to the battery positive voltage, V_{BAT}, the switch 285 has not failed (e.g., is not shorted). If the switch status module 230 measures a voltage of 0V at the junction, J2, the switch 285 has failed (e.g., is shorted). A similar procedure is performed for testing the brake switch 275 by measuring the voltage at the junction, J1.

The controller 200 includes combinations of hardware and software that are operable to, among other things, control the operation of the device, monitor the operation and status of the device, control the drive module 265 and brake module 260, activate the worklight 220, etc. In some embodiments, the controller 200 includes a plurality of electrical and electronic components that provide power, operational control, and protection to the components and modules within the controller 200 and/or device 100. For example, with reference to FIG. 4, the controller 200 includes, among other things, a processing unit 300 (e.g., a microprocessor, a microcontroller, or another suitable programmable device), a memory 305, input units 310, and output units 315. The processing unit 300 includes, among other things, a control unit 320, an arithmetic logic unit (“ALU”) 325, and a plurality of registers 330 (shown as a group of registers in FIG. 4), and is implemented using a known computer architecture, such as a modified Harvard architecture, a von Neumann architecture, etc. The processing unit 300, the memory 305, the input units 310, and the output units 315, as well as the various modules connected to the controller 200 are connected by one or more control and/or data buses (e.g., common bus 335). The control and/or data buses are shown generally in FIG. 4 for illustrative purposes. The use of one or more control and/or data buses for the interconnection between and communication among the various modules and components would be known to a person skilled in the art in view of the invention described herein. In some embodiments, the controller 200 is implemented partially or entirely on a semiconductor (e.g., a field-programmable gate array [“FPGA”]semiconductor) chip, such as a chip developed through a register transfer level (“RTL”) design process.

The memory 305 includes, for example, a program storage area and a data storage area. The program storage area and the data storage area can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The processing unit 300 is connected to the memory 305 and executes software instructions that are capable of being stored in a RAM of the memory 305 (e.g., during execution), a ROM of the memory 305 (e.g., on a generally permanent basis), or another non-transitory computer readable medium such as another memory or a disc. Software included in the implementation of the device can be stored in the memory 305 of the controller 200. The software includes, for example, firmware, one or more applications, program data, filters, rules, one or more program modules, and other executable instructions. The controller 200 is configured to retrieve from memory and execute, among other things, instructions related to the control processes and methods described herein. In other constructions, the controller 200 includes additional, fewer, or different components. The control processes and methods are described below with respect to FIGS. 5-10 and processes 400, 500, 600, 700, and 800.

FIG. 5 illustrates a process 400 for energizing one or more printed circuit boards (“PCBs”) within the device 100. In some embodiments, for example, the controller 200 and associated control electronics are all mounted or connected to a single PCB (e.g., PCB 295). In other embodiments, more than one PCB is included within the device 100. For example, the multiple PCBs can be distributed throughout different portions of the device 100 due size and/or space constraints, etc. With respect to the embodiments of the invention described herein, the device 100 will be described with respect to the embodiments of the invention that include a single PCB.

The process 400 begins with the PCB being de-energized (step 405). At step 410, the controller 200 or circuit board energize circuit 215 determines whether a first switch (e.g., the sharkfin switch 255, the nose switch 245, etc.) or a second switch (e.g., the sharkfin switch 255, the nose switch 245, etc.) is activated. If neither of the first or second switches is activated, the process 400 returns to step 405 and the PCB remains de-energized. If, at step 410, one of the first switch or the second switch is activated, the PCB is energized (step 415). Following the energization of the PCB at step 415, a timer is set (step 420) and the voltage of the battery pack 135 is monitored (step 425). If the voltage of the battery pack 135 is less than or equal to a threshold value, X Volts (e.g., approximately 6V, approximately 12V, etc.) (step 430), the PCB is de-energized at step 450. If, alternatively, the voltage of the battery pack 135 is not less than or equal to the threshold value, X Volts, the battery voltage continues to be monitored at step 425.

After the timer has been set at step 420, the timer is started (step 435). The timer is, for example, an energy saving component of the device 100. The timer can be set to a value of between, for example, one minute and 30 minutes, one minute and 60 minutes, etc. The timer is operable to limit the power drained from the battery pack 135 during prolonged period of device inactivity. The timer is, for example, internal to the controller 200 and can be used to count down (e.g., to zero) from a specified value (e.g., one minute) or count up to a specified value (e.g., one minute). Specifically, the controller 200 determines whether the first switch or the second switch has been activated within the period of time designated by the timer. In some embodiments, the period of time is approximately 20 minutes. If the first switch or the second switch has been activated within the past 20 minutes (step 440), the timer is reset (step 445) and restarted (step 435). If neither the first switch nor the second switch has been activated within the period of time, the PCB is de-energized (step 450) to prevent the battery pack 135 from being depleted during a prolonged period of device inactivity.

FIG. 6 illustrates a process 500 for controlling the worklight 220 of the device 100. The worklight 220 of the device 100 is operable to, for example, illuminate an area in front of the device 100 (e.g., an object or surface being fastened, etc.). The process 500 is executed by the controller 200 following the energization of the PCB as described above with respect to the process 400 and FIG. 5. The process 500 begins with the PCB being energized and the worklight 200 being in an off or deactivated state (step 505). The controller 200 then determines whether the first switch or the second switch is activated (step 510). If neither of the first or second switches has been activated, the process 500 returns to step 505 where the worklight 220 remains off. If, at step 510, either of the first switch or the second switch has been activated, the worklight 220 is activated or turned on (step 515).

Following the activation of the worklight 220, the controller 200 determines whether the first switch and the second switch are deactivated (step 520) and monitors the voltage of the battery pack 135 (step 525). If the voltage of the battery pack 135 is less than or equal to the threshold value, X Volts (step 530), the worklight 220 is deactivated or turned off (step 565). If the voltage of the battery pack 135 is not less than or equal to the threshold value, the controller 200 determines whether the voltage of the battery pack 135 is greater than the threshold value and less than a second threshold value, Y Volts (e.g., between approximately 12V and approximately 18V, etc.) (step 535). If the voltage of the battery pack 135 is less than the second threshold value, Y Volts, the worklight 220 is turned on and off (e.g., blinked) (step 540) to indicate that the battery pack 135 does not have sufficient energy to fire a fastener (e.g., a nail, a staple, a brad, etc.). In some embodiments, the threshold values for X volts and Y volts are set based on the type of fastener and the depth of the fastener (e.g., using a setting from the depth selection input 120). If the voltage of the battery pack 135 is greater than or equal to the second threshold value at step 535, the process 500 returns to step 525 where the voltage of the battery pack 135 is again monitored.

If, at step 520, the first switch and second switch are deactivated, a timer is set (step 545). The timer is set to a value of, for example, one minute or between 1 second and five minutes. The timer is used to deactivate or turn off the worklight 220 when the device 100 is not in use or has been inactive for a period of time. The timer is, for example, internal to the controller 200 and can be used to count down (e.g., to zero) from a specified value (e.g., one minute) or count up to a specified value (e.g., one minute). At step 550, the timer is started. The controller 200 then determines whether the first switch of the second switch has been activated within the time period (step 555). If either of the first switch or the second switch has been activated within the time period, the timer is reset (step 560) and restarted (step 550). If, alternatively, neither the first switch nor second switch has been activated within the period of time measured by the timer, the worklight 220 is deactivated or turned off (step 565).

FIGS. 7 and 8 illustrate a process 600 for operating the device 100. The device 100 can be operated in any of a variety of modes. For example, the device 100 can be operated in a single-fire mode, in which a single fastener is fired following a specified sequence of events, or a bump-fire mode, in which fasteners are able to be fired at a faster pace (e.g., based on multiple possible sequences of events). The process 600 begins at step 605 with the PCB being energized as described above with respect to FIG. 5 and process 400. The selector switch 250, or its input to the controller 200, is then checked to determine whether the device 100 is set in the bump-fire mode (step 610). If the device 100 is not set to the bump-fire mode, the device 100 is operated in the single fire mode (step 615). The controller 200 determines whether the second switch is activated and if the third switch is deactivated (step 620). If, at step 620, the second switch is not activated and/or the third switch is not deactivated, the second switch and/or the third switch are released or deactivated (e.g., made non-conductive, enter an open state, etc.) (step 625) before another fastener is fired and the single fire mode is again initiated (step 615). If, at step 620, the second switch is activated and the third switch is deactivated, the controller 200 determines whether the third switch is activated within a period of time (e.g., 1-20 seconds) (step 630). If the third switch is not activated within the period of time, the second switch is deactivated (step 625) before another fastener is fired and the single fire mode is again initiated (step 615). However, if, at step 630, the third switch is activated within the period of time, the fastener is fired (step 635).

Alternatively, if, at step 610, the selector switch 250, or its input to the controller 200, is set in the bump fire mode, the process 600 proceeds to section A, shown in and described with respect to FIG. 8. When the device 100 is set in the bump fire mode (step 640), there are multiple sequences of switch activations that can ultimately result in a fastener being fired. For example, as illustrated in FIG. 8, the controller 200 determines whether the second switch is activated (step 645). If, at step 645, the second switch is not activated, the controller 200 determines whether the third switch is activated (step 650). If, at step 650, the third switch is not activated, the bump fire mode is reinitialized at step 640. If, at step 650, the third switch is activated, the controller 200 determines whether the second switch is also activated within a period of time (e.g., between 1-20 seconds) (step 655). If the second switch is not activated within the period of time, the third switch is released or deactivated (e.g., made non-conductive, enter an open state, etc.) (step 660) before a fastener is fired and the bump fire mode is reinitialized (step 640). If, at step 655, the second switch is activated within the period of time, a fastener is fired (step 675), the second and third switches are then released or deactivated (e.g., made non-conductive, enter an open state, etc.) (step 670) before another fastener is fired and the bump fire mode is reinitialized (step 640).

If, at step 645, the controller 200 determines that the second switch is activated, the controller 200 determines whether the third switch 665 is also activated within a period of time (e.g., between 1-20 seconds). If the third switch is not activated within the period of time, the second switch is released (step 670) before a fastener is fired and the bump fire mode is reinitialized (step 640). If, at step 665, the third switch is activated within the period of time, a fastener is fired (step 675), the second and third switches are then released (step 670) before another fastener is fired and the bump fire mode is reinitialized (step 640).

FIG. 9 illustrates a fastener firing process 700 for the device 100. For example, in steps 635 and 675 of process 600, the controller 200 determines that a fastener should be fired. The process 700 illustrates the controlled firing operation of the device 100. The process 700 begins with the drive switches 285 and 290 for the motor 270 being activated (step 705). After the drive switches 285 and 290 have been activated, the controller 200 waits to receive one or more signals from one or more sensors (e.g., Hall Effect sensors modules 205 and/or 210). If a signal from the one or more sensors is received, the controller 200 determines whether the signal or signals were received in a proper time period and in a proper sequence (i.e., when two or more sensors are present), as described above. A proper time period or a proper sequence is indicative of the device 100 having completed the firing of the fastening device without, for example, becoming jammed or otherwise entering and error or fault condition.

If, at step 715, the signal or signals from the one or more sensors are not received in the manner described above, the process 700 returns to step 710 and awaits additional signals from the one or more sensors. If, at step 715, the signal or signals from the one or more sensors are received in the manner described above to indicate that the fastener firing operation was completed or successful, the drive switches 285 and 290 are deactivated (step 720), the brake switches 275 and 280 are activated (step 725), and the brake switches 275 and 280 are deactivated (step 730). An appropriate time period or delay can be provided by the controller 200 between each of steps 720, 725, and 730. An appropriate time period corresponds to, for example, a time period (or greater than a time period) for completing each of steps 720, 725, and 730.

As an illustrative example of an appropriate time period, when the drive switches 285 and 290 are deactivated at step 720, the brake switches 275 and 280 are not activated at step 725 until the driver switches 285 and 290 are fully deactivated. Depending upon the type of switch employed for the drive switches 285 and 290 (e.g., FETs), the amount of time necessary to deactivate them may vary. However, in general, the time period for delay will be less than approximately one or two seconds, and in many instances, less than one second. The time period appropriate to delay following the activation of the brake switches 275 and 280 corresponds to an amount of time needed for the motor to stop rotating. Such a time period can be selected to be an arbitrarily high value (e.g., several seconds) to ensure that the motor is stopped, can be calculated by the controller 200 (e.g., based on the speed of the motor, etc.), can be preprogrammed based on characteristics of the motor 270, can be based on when the rotor of the motor 270 stops rotating (e.g., zero motor speed), etc. The delay is included such that the drive switches 285 and 290 and the brake switches 275 and 280 are not both activated at the same time (e.g., creating a potential motor short circuit). After the brake switches 275 and 280 are deactivated at step 730, the process 700 returns to step 705 for a subsequent firing sequence (as determined by executing process 600).

If, at step 710, no signals from the one or more sensors are received, the controller 200 determines whether a timeout condition has occurred (step 735). A timeout condition corresponds to a period of time following the activation of the drive switches 285 and 290 beyond which signals from the one or more sensors should have been received. In general, the time period for identifying a timeout condition will be less than approximately one to three seconds, and in many instances, less than one second. If a timeout condition has not yet occurred (e.g., is within the time period), the process 700 returns to step 710 and determines whether signals from the one or more sensors have been received. If, at step 735, a timeout condition has occurred, the drive switches 285 and 290 are deactivated (step 740), the brake switches 275 and 280 are activated (step 745), and the brake switches 275 and 280 are deactivated (step 750). Appropriate time delays, as described above, can also be inserted by the controller 200 between steps 740, 745, and 750.

At step 755, the controller 200 determines whether the number of consecutive timeout conditions has exceeded a third threshold value (e.g., two consecutive timeout conditions, three consecutive timeout conditions, etc.). If the third threshold value has not been exceeded, the process 700 returns to step 705 for a subsequent firing sequence (as determined by executing process 600). If, at step 755, the third threshold value has been met or exceeded, the controller 200 prevents the device 100 from operating (step 760) (e.g., the thermal fuse 235 is intentionally blown or opened). The consecutive timeout conditions may be indicative of, for example, the device 100 being jammed or otherwise preventing a fastening device from being fired.

FIG. 10 illustrates a process 800 for evaluating the health of the drive switches 285 and 290 and the brake switches 275 and 280. The process 800 is executed in conjunction with each of processes 400, 500, 600, and 700, and is active when the PCB is energized (as provided in process 400). When the PCB is energized (step 805), the controller 200 checks the health of the drive switches 285 and 290 (step 810), as described above. If the drive switches 285 and 290 are not healthy (e.g., are shorted), the device 100 is disabled (step 820) (e.g., the thermal fuse 235 is intentionally blown or opened). If, at step 810, the drive switches 285 and 290 are healthy, the controller 200 determines whether the brake switches 275 and 280 are healthy (step 815). If the brake switches 275 and 280 are not healthy (e.g., are shorted), the device 100 is disabled (step 820) (e.g., the thermal fuse 235 is intentionally blown or opened). If, at step 815, the brake switches 275 and 280 are healthy, the process 800 returns to step 805 to determine whether the PCB is still energized.

Thus, the invention provides, among other things, a device, such as a fastener device, that includes a variety of safety and control operations that are used to control the device without the use of, for example, a mechanical linkage or mechanical safety assembly connected between a trigger of the device and a firing portion of the device. Various features and advantages of the invention are set forth in the following claims.

What is claimed is:

1. A fastening device comprising:
a trigger portion;
a nose portion;
a fastener magazine configured to receive a fastener;
a first switch, an operational state of the first switch being one of an open state and a closed state;
a second switch, an operational state of the second switch being one of an open state and a closed state; and
a controller configured to
receive a first signal associated with the operational state of the first switch,
receive a second signal associated with the operational state of the second switch, and
initiate a firing operation for the fastener when the first signal associated with the operational state of the first switch is indicative of the first switch being in the closed state and when the second signal associated with the operational state of the second switch is indicative of the second switch being in the closed state.

2. The fastening device of claim 1, further comprising a third switch, an operational state of the third switch being one of an open state and a closed state, and wherein the controller is further configured to receive a third signal associated with the operational state of the third switch.

3. The fastening device of claim 2, wherein the controller is energized when the first signal associated with the operational state of the first switch is indicative of the first switch being in the closed state or when the third signal associated with the operational state of the third switch is indicative of the third switch being in the closed state.

4. The fastening device of claim 2, further comprising a worklight, the worklight configured to be illuminated when the first signal associated with the operational state of the first switch is indicative of the first switch being in the closed state or when the third signal associated with the operational state of the third switch is indicative of the third switch being in the closed state.

5. The fastening device of claim 1, further comprising a rechargeable battery pack removably securable to the fastening device and including a plurality of battery cells.

6. The fastening device of claim 5, wherein the controller is further configured to monitor a voltage of the battery pack, and prevent the initiation of the firing operation for the fastener when the voltage of the battery pack is below a threshold voltage value.

7. The fastening device of claim 1, further comprising a drive switch and a brake switch.

8. The fastening device of claim 7, wherein the controller is further configured to determine if the drive switch has been short circuited or if the brake switch has been short circuited.

9. The fastening device of claim 8, further comprising a thermal fuse.

10. The fastening device of claim 9, wherein the thermal fuse is intentionally blown when one of the drive switch and the brake switch has been short circuited.

11. The fastening device of claim 1, wherein the first switch is associated with the trigger portion of the fastening device and the second switch is associated with the nose portion of the fastening device.

12. The fastening device of claim 11, wherein the fastening device does not include a mechanical safety linkage connecting the trigger portion and the nose portion.

13. A method of operating a fastening device that includes a controller, the method comprising:
receiving, at the controller, a first signal associated with an operational state of a first switch, the operational state of the first switch being one of an open state and a closed state;
receiving, at the controller, a second signal associated with an operational state of a second switch, the operational state of the second switch being one of an open state and a closed state;
initiating a firing operation for a fastener when the first signal associated with the operational state of the first switch is indicative of the first switch being in the closed state and when the second signal associated with the operational state of the second switch is indicative of the second switch being in the closed state; and
firing the fastener following the initiation of the firing operation.

14. The method of claim 13, further comprising
receiving, at the controller, a third signal associated with an operational state of a third switch, the operational state of the third switch being one of an open state and a closed state; and
energizing the controller when the first signal associated with the operational state of the first switch is indicative of the first switch being in the closed state or when the third signal associated with the operational state of the third switch is indicative of the third switch being in the closed state.

15. The method of claim 13, further comprising removably securing a battery pack including a plurality of battery cells to the fastening device.

16. The method of claim 15, further comprising monitoring a voltage of the battery pack, and preventing the initiation of the firing operation when the voltage of the battery pack is below a threshold voltage value.

17. The method of claim 13, further comprising determining if a drive switch of the fastening device has been short circuited or if a brake switch of the fastening device has been short circuited.

18. The method of claim 13, wherein the first switch is associated with a trigger portion of the fastening device and the second switch is associated with a nose portion of the fastening device, and
wherein the fastening device does not include a mechanical safety linkage connecting the trigger portion of the fastening device and the nose portion of the fastening device.

19. A fastening device including a trigger portion, a nose portion, and a fastener magazine configured to receive a fastener, the fastening device comprising:
a first switch, an operational state of the first switch being one of an open state and a closed state;
a second switch, an operational state of the second switch being one of an open state and a closed state; and
a controller configured to
receive a first signal associated with the operational state of the first switch,
receive a second signal associated with the operational state of the second switch, and
initiate a fastener firing operation when the first signal associated with the operational state of the first switch is indicative of the first switch being in the closed state and when the second signal associated with the operational state of the second switch is indicative of the second switch being in the closed state.

20. The fastening device of claim 19, wherein the controller is configured to operate in one of a first mode of operation and a second mode of operation.

21. The fastening device of claim 20, wherein, in the first mode of operation, the fastener firing operation is initiated when the first signal associated with the operational state of the first switch is received prior to the second signal associated with the operational state of the second switch, the first signal being indicative of the first switch being in the closed state, the second signal being indicative of the second switch being in the closed state, and the second signal being received by the controller within a predetermined time period of the controller receiving the first signal.

22. The fastening device of claim 20, wherein, in the second mode of operation, the fastener firing operation is initiated when the first signal associated with the operational state of the first switch is received prior to the second signal associated with the operational state of the second switch, the first signal being indicative of the first switch being in the closed state, the second signal being indicative of the second switch being in the closed state, and the second signal being received by the controller within a predetermined time period of the controller receiving the first signal, or
the fastener firing operation is initiated when the second signal associated with the operational state of the second switch is received prior to the first signal associated with the operational state of the first switch, the second signal being indicative of the second switch being in the closed state, the first signal being indicative of the first switch being in the closed state, and the first signal being received by the controller within a predetermined time period of the controller receiving the second signal.

23. The fastening device of claim 19, further comprising a thermal fuse.

24. The fastening device of claim 23, wherein the thermal fuse is intentionally blown when a fault condition of the fastening device is present.

25. The fastening device of claim 24, wherein the fault condition of the fastening device includes the fastening device becoming jammed.

26. The fastening device of claim 24, wherein the fault condition includes one of a drive switch being short circuited and a brake switch being short circuited.

27. The fastening device of claim 24, wherein the fastening device is prevented from operating when the thermal fuse has been blown.

28. The fastening device of claim 24, further comprising a first sensor configured to generate a first sensor signal and a second sensor configured to generate a second sensor signal.

29. The fastening device of claim 28, wherein the fault condition of the fastening device includes the controller determining that the first sensor signal and the second sensor signal were one of not received in a predetermined period of time or not received in a predetermined sequence.
